(19) United States
(12) Patent Application Publication
(10) Pub. No.: US 2018/0321665 A1
(43) Pub. Date: Nov. 8, 2018

(54) SCHEDULING METHOD AND PROGRAM FOR A SUBSTRATE TREATING APPARATUS

(71) Applicant: SCREEN Holdings Co., Ltd., Kyoto (JP)

(72) Inventor: Masahiro YAMAMOTO, Kyoto-shi, Kyoto (JP)

(21) Appl. No.: 15/773,413

(22) PCT Filed: Oct. 13, 2016
(86) PCT No.: PCT/JP2016/080438

§ 371 Date: May 3, 2018

(30) Foreign Application Priority Data
Nov. 6, 2015 (JP) 2015-218362

(51) Int. Cl. G05B 19/418

(52) U.S. Cl. CPC G05B 19/41865; G05B 2219/32234; G05B 2219/45031

(57) ABSTRACT

When a maintenance process for treating sections has reached its life at the time of allocating treatment of a certain substrate which uses the resources of the treating sections, the controller, based on a priority setting set beforehand by the user, allocates the treatment of the substrate if the priority setting is substrate treatment priority, and allocates the maintenance process before the treatment of the substrate if the priority setting is maintenance priority. This realizes treatment reflecting desires of the user concerning priority processes.

### TECHNICAL FIELD

This invention relates to a scheduling method and program for a substrate treating apparatus that performs predetermined treatment of semiconductor wafers, substrates for liquid crystal displays, substrates for plasma displays, substrates for organic ELs, substrates for FEDs (Field Emission Displays), substrates for optical displays, substrates for magnetic disks, substrates for magneto-optical disks, substrates for photomasks and substrates for solar cells (hereinafter called simply the substrates), and more particularly relates to a technique for preparing a schedule prior to an actual execution of treatment.

### BACKGROUND ART

Conventionally, this type of method sets “lifetimes” specifying durations of life according times for which treating liquids have been used, and fixedly allocates a liquid changing process for each lifetime to a resource of a treating section that uses the treating liquid. And, as if threading between regular liquid changing processes allocated in this way, use timing of each resource is allocated for the substrates in a carrier. When an incidental liquid changing process incidental to a particular treatment overlaps, adjoins or occurs close to a regular liquid changing process, the method deletes the regular liquid changing process, and allocates the particular treatment with priority (see Patent Document 1, for example).

The above lifetimes may be replaced with “life counts” set to specify life durations of treating liquids according to the number of times used. In this case also, as in the above case, when the number of times of life is reached, a regular liquid changing process is allocated. When the above overlapping of an incidental liquid changing process incidental to the particular treatment occurs, this method deletes the regular liquid changing process, and allocates the particular treatment with priority

In a single-substrate treatment for treating one substrate at a time, when the resource of a treating section has been used for a predetermined time (lifetime), or used a predetermined number of times (life count), a cleaning process may be carried out to clean the treating section for attaining clean treating environment. In these cases also, allocations are made according to life as described above. That is, maintenance processes such as liquid changing processes according to life and cleaning processes according to life will be allocated with priority.

### PRIOR ART DOCUMENT

### Patent Document

[Patent Document 1]

Unexamined Patent Publication No. 2007-266442

### SUMMARY OF INVENTION

### Technical Problem

However, the conventional example noted above has the following problem.

The user of the substrate treating apparatus has a desire for “substrate treatment priority”, hoping to give all of a plurality of substrates stored in the same carrier treatment with the same treating liquid or in the same treating environment, or a desire for “maintenance priority” to perform treatment rigorously complying with a life such that, when the life is reached, a maintenance process is allocated even halfway through treatment of the plurality of substrates stored in the same carrier. The desire for substrate treatment priority may include a case of hoping to perform treatment with the same treating liquid or in the same treating environment for a plurality of carriers even when a life has been reached, or in an extreme case (where the life count is 1), hoping to perform a maintenance process for each substrate.

That is, although the conventional method shifts the maintenance process in view of the incidental liquid changing process, the maintenance process, the maintenance process is moved, after all, according to an allocating situation at the time of scheduling. There is, therefore, a problem of being unable to reflect the user's desires concerning priority processes such as the maintenance priority and substrate treatment priority.

This invention has been made having regard to the state of the art noted above, and its object is to provide a scheduling method and program for a substrate treating apparatus capable of reflecting the user's desires concerning priority processes, by enabling a selection between maintenance priority and substrate treatment priority

### Solution to Problem

To fulfill the above object, this invention provides the following construction.

This invention provides a scheduling method for a substrate treating apparatus having a treating section for treating, one at a time, a plurality of substrates stored in a carrier, and a controller for determining resource use timing before actually starting treatment of the plurality of substrates using resources of the treating section; wherein, when there is a maintenance process for the treating section having reached a life at a time of allocating treatment of a certain substrate which uses the resources of the treating section, the controller, based on a priority setting for one of a maintenance priority and a substrate treatment priority set beforehand by the user, allocates the treatment of the substrate W in a case where the priority setting is the substrate treatment priority, and allocates a maintenance process before the treatment of the substrate W in a case where the priority setting is the maintenance priority.

[Functions and Effects] According to this invention, when a maintenance process for the treating section has reached its life at the time of allocating treatment of a certain substrate which uses the resources of the treating section, the controller, based on a priority setting set beforehand by the user, allocates the treatment of the substrate if the priority setting is substrate treatment priority, and allocates the maintenance process before the treatment of the substrate if the priority setting is maintenance priority. This realizes treatment reflecting desires of the user concerning priority processes.

In this invention, it is preferred that a process job having set thereto a recipe specifying a sequence of treatment corresponding to each substrate, and a control job having set thereto as to a pertinent carrier and corresponding to each substrate, are set beforehand; and the substrate treatment priority enables a setting of timing for allocating the maintenance process for one of each substrate, each process job, and each control job.

The setting of timing for allocating the maintenance process for each substrate, each process job, or each control job enables changing of timing of executing the maintenance process for each substrate, each group of substrates treated according to the same recipe, or each carrier. This can meticulously reflect the desires of the user concerning processes.

In this invention, it is preferred that the maintenance process is one of a liquid changing process for changing a liquid used in the treating section and a cleaning process for cleaning the treating section.

An execution of the liquid changing process for changing a liquid used in the treating section or the cleaning process for cleaning the treating section will change the treating conditions and treating environment. The user can therefore control a substrate treatment history by changing, as desired by the user, timing of executing these as maintenance process.

Further, this invention provides a scheduling program for a substrate treating apparatus having a treating section for treating, one at a time, a plurality of substrates stored in a carrier, and a controller for determining resource use timing before actually starting treatment of the plurality of substrates using resources of the treating section; wherein, when there is a maintenance process for the treating section having reached a life at a time of allocating treatment of a certain substrate which uses the resources of the treating section, the controller, based on a priority setting for one of a maintenance priority and a substrate treatment priority set beforehand by the user, allocates the treatment of the substrate W in a case where the priority setting is the substrate treatment priority, and allocates a maintenance process before the treatment of the substrate W in a case where the priority setting is the maintenance priority.

### Advantageous Effects of Invention

With the scheduling method for the substrate treating apparatus according to this invention, when a maintenance process for the treating section has reached its life at the time of allocating treatment of a certain substrate which uses the resources of the treating section, the controller, based on a priority setting set beforehand by the user, allocates the treatment of the substrate if the priority setting is substrate treatment priority, and allocates the maintenance process before the treatment of the substrate if the priority setting is maintenance priority. This realizes treatment reflecting desires of the user concerning priority processes.

### BRIEF DESCRIPTION OF THE DRAWINGS

FIG. 1 is a plan view showing an outline construction of a substrate treating apparatus according to an embodiment;

FIG. 2 is a side view showing the outline construction of the substrate treating apparatus according to the embodiment;

FIG. 3 is a block diagram of the substrate treating apparatus according to the embodiment;

FIG. 4 is a flow chart showing schedule preparation;

FIG. 5 is a time chart showing a state where blocks are allocated on a provisional timetable;

FIG. 6 is a time chart showing a schedule preparation process with substrate treatment priority;

FIG. 7 is a time chart showing a schedule preparation process with substrate treatment priority;

FIG. 8 is a time chart showing a schedule preparation process with maintenance priority;

FIG. 9 is a time chart showing a schedule preparation process with maintenance priority;

FIG. 10 is a time chart showing a schedule preparation process with maintenance priority;

FIG. 11 is a time chart showing a schedule preparation process with maintenance priority;

FIG. 12 is a time chart showing a schedule preparation process with maintenance priority;

FIG. 13 is a time chart showing a schedule preparation process with substrate treatment priority;

FIG. 14 is a time chart showing a schedule preparation process with substrate treatment priority;

FIG. 15 is a time chart showing a schedule preparation process with substrate treatment priority;

FIG. 16 is a time chart showing a schedule preparation process with substrate treatment priority;

FIG. 17 is a time chart showing a schedule preparation process with substrate treatment priority;

FIG. 18 is a schematic view showing an example of maintenance process timing with substrate treatment priority (each substrate);

FIG. 19 is a schematic view showing of maintenance process timing with substrate treatment priority (each process job); and

FIG. 20 is a schematic view showing of maintenance process timing with substrate treatment priority (each control job).

### DESCRIPTION OF EMBODIMENTS

One embodiment of this invention will be described hereinafter with reference to the drawings.

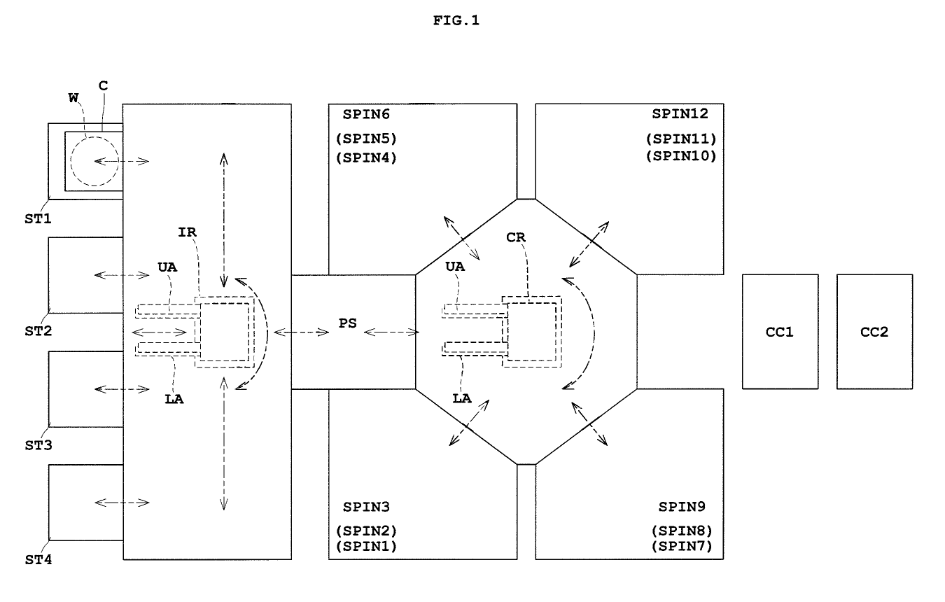

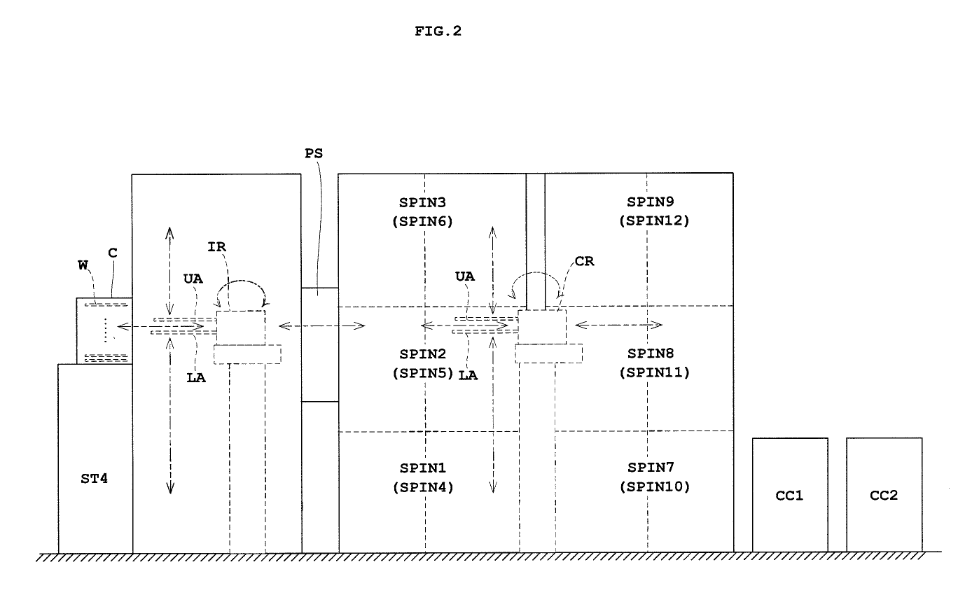

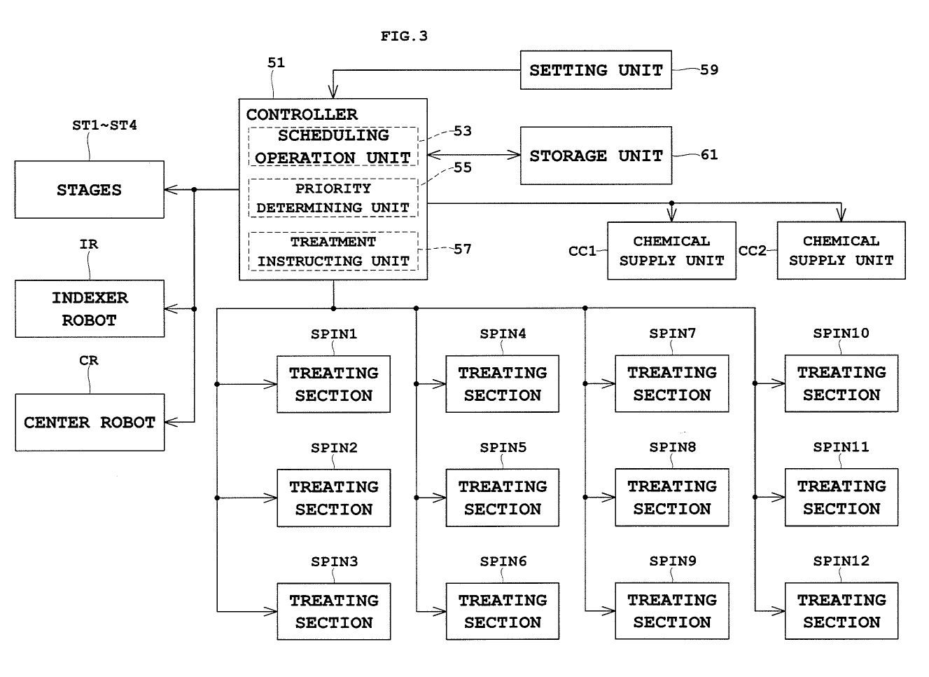

FIG. 1 is a plan view showing an outline construction of a substrate treating apparatus according to the embodiment. FIG. 2 is a side view showing the outline construction of the substrate treating apparatus according to the embodiment. FIG. 3 is a block diagram of the substrate treating apparatus according to the embodiment.

The substrate treating apparatus according to the embodiment is a single-substrate type apparatus which treats one substrate W at a time. Specifically, the apparatus includes stages ST1-ST4, an indexer robot IR, a pass section PS, a center robot CR, treating sections SPIN1-SPIN12, and chemical supply sections CC1 and CC2.

The stages ST1-ST4 receive carriers C containing a plurality of substrates W. Each of the stages ST1-ST4 is constructed capable of receiving one carrier C placed thereon. The indexer robot IR takes a substrate W out of a carrier C on one of the stages ST1-ST4, and puts into the carrier C the substrate W treated in one of the treating sections SPIN1-SPIN12.

The indexer robot IR has two different arms arranged one above the other (upper arm UA and lower arm LA) to be capable of substantially simultaneously carrying out operations to take a substrate W out of the carrier C and putting a treated substrate W into the carrier C. The indexer robot IR is constructed horizontally movable to access all of the stages ST1-ST4, and is also constructed movable up and down to receive and deliver the substrates W. Further, the indexer robot IR is constructed swivelable about a vertical axis to be opposed to the stages ST1-ST4 and to the pass section PS.

The pass section PS receives the substrates W taken out of the carrier C, and receives the substrates W treated in the treating sections SPIN1-SPIN12. The pass section PS is constructed accessible to the indexer robot IR and center robot CR. The substrates W can therefore be transferred indirectly between the indexer robot IR and center robot CR.

The center robot CR is disposed adjacent the pass section PS, and is located centrally of the treating sections SPIN1-SPIN12 in plan view. The center robot CR, like the indexer robot IR, has two different arms arranged one above the other (upper arm UA and lower arm LA) to be capable of substantially simultaneously carrying out operations to unload a treated substrate W from and to load a substrate to be treated into any one of the treating sections SPIN1-SPIN12.

The treating sections SPIN1-SPIN12 include, as stacked in order from bottom, treating sections SPIN1, SPIN4, SPIN7 and SPIN10, treating sections SPIN2, SPIN5, SPIN8 and SPIN11, and treating sections SPIN3, SPIN6, SPIN9 and SPIN12. In plan view, treating sections SPIN1-SPIN3, treating sections SPIN4-SPIN6, treating sections SPIN7-SPIN9, and treating sections SPIN10-SPIN12 are arranged in the same positions. The center robot CR is constructed movable up and down and swivelable about a vertical axis to be capable of accessing the pass section PS and each of the treating sections SPIN1-SPIN12.

Each of the treating sections SPIN1-SPIN12 successively treats one substrate W at a time, and some, for example, perform cleaning treatment of substrates W by supplying a cleaning liquid while spinning the substrates W. The chemical supply sections CC1 and CC2, for example, keep chemical solutions produced for use in the treating sections SPIN1-SPIN12, and supply various chemical solutions (including chemical solutions such as acidic, alkaline and alcoholic ones, and what is called functional water such as warm water, ozone water and carbonated water) according to treatment timing in the treating sections SPIN1-SPIN12. Each chemical solution has a use limit specified by a lifetime which specifies the life of the chemical solution according to an elapsed time from the point of time of its preparation, and a life count which specifies the life of the chemical solution according to the number of use times of the chemical solution. When the use limit has been reached, that is when the life has been reached, a maintenance process is carried out to dispose of the chemical solution and prepare a new solution. Consequently, the treating sections SPIN1-SPIN12 having been supplied with that chemical solution from the chemical treatment section CC1 or CC2 cannot perform treatment during the maintenance process. Such maintenance process has allocations controlled as described hereinafter.

The parts and sections described above are controlled overall by a controller 51. This controller 51 has a CPU and other components not shown. Functionally, the controller 51 includes a scheduling unit 53, a priority determining unit 55, and a treatment instructing unit 57. Further, the controller 51 has a setting unit 59 and a storage unit 61 connected to thereto.

The above stages ST1-ST4, indexer robot IR, pass section PS, center robot CR, treating sections SPIN1-SPIN12, and chemical supply sections CC1 and CC2 correspond to the “resources” in this invention.

The setting unit 59 is used when the user sets, in advance of scheduling, a priority setting for a choice, in the case of a chemical solution or the like having reached the life, between a maintenance priority giving priority to maintenance process rather than continuing treatment of substrates W and a substrate treatment priority for continuing the treatment of substrates W even if the life has been reached. It is used also when the user instructs how the priority setting should be made. With the substrate treatment priority in the priority settings, a recipe specifying a sequence of treatment can be set beforehand for each substrate W, which carrier C is relevant for each process job matched with each substrate W, or timing of a maintenance process for each control job matched with each substrate W. Further, the setting unit 59 is used also when setting the recipe specifying the sequence of substrate treatment, and when giving instructions for scheduling start.

The storage unit 61 stores various recipes set beforehand. It also stores a program for scheduling as described hereinafter, and treatment schedules of substrates W prepared with this program.

The scheduling operation unit 53 prepares as a block a single schedule of each treating section corresponding to a recipe matched with each substrate W according to an order of treatment of a plurality of substrates W. And the blocks of the substrates W are successively allocated with the lives of the chemical solutions and the like. At this time, the blocks overlapping the lives are treated according to the priority setting, and the blocks of all the substrates W are allocated, to complete an entire schedule. The treatment according to the priority setting is determined by the priority determining unit 55. The entire treatment schedule prepared in this way is stored in the storage unit 61, read by the treatment instructing unit 57, and executed on instructions given to each resource. Thus, actual treatment is carried out.

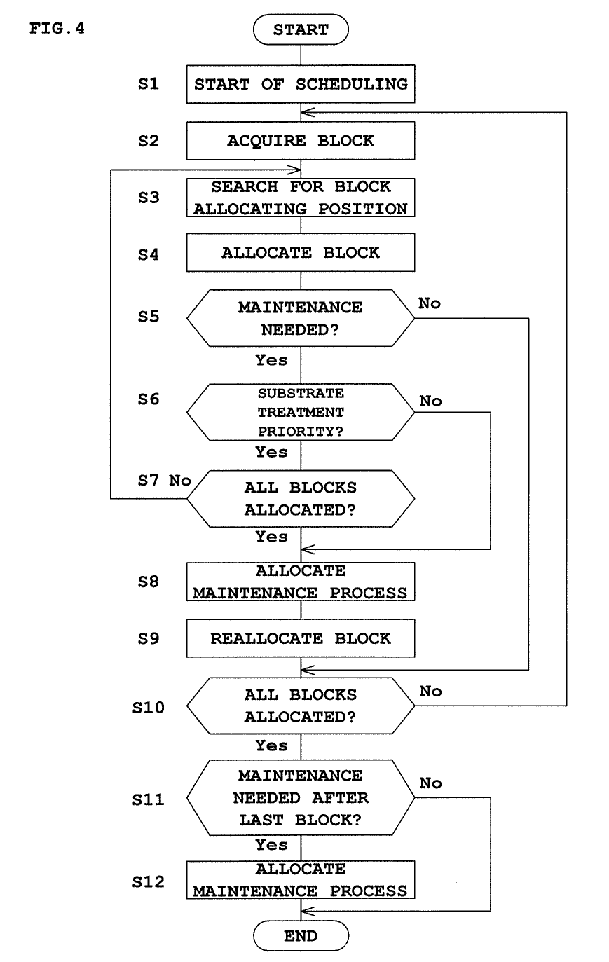

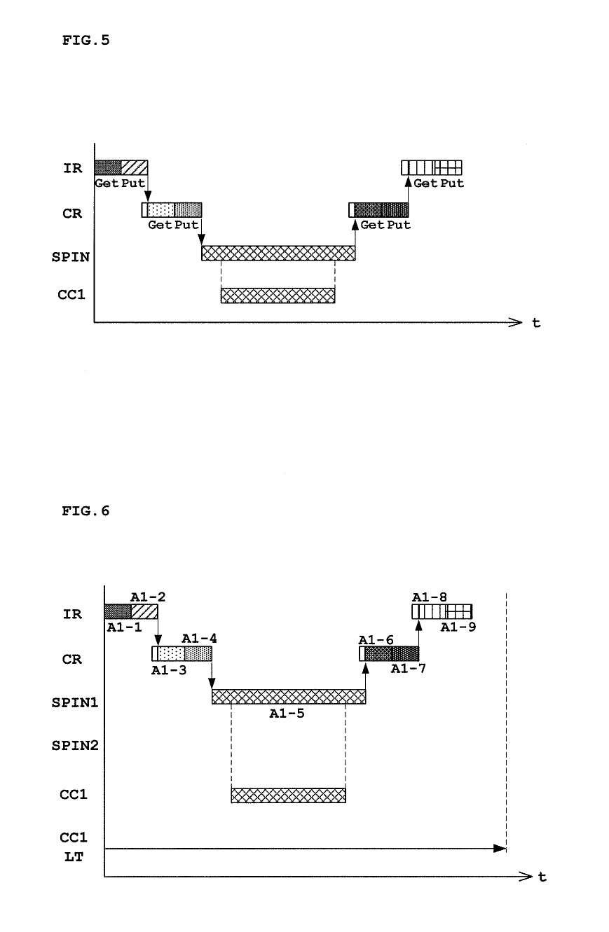

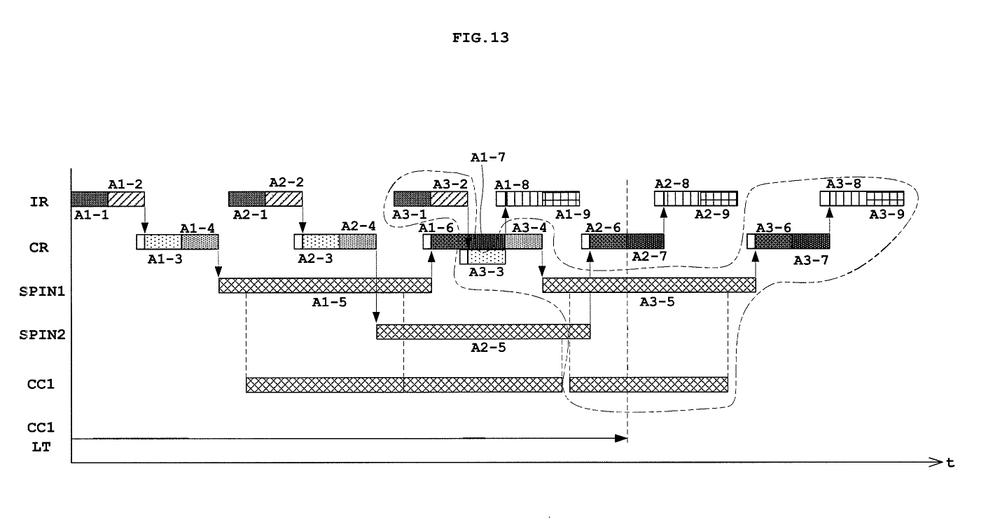

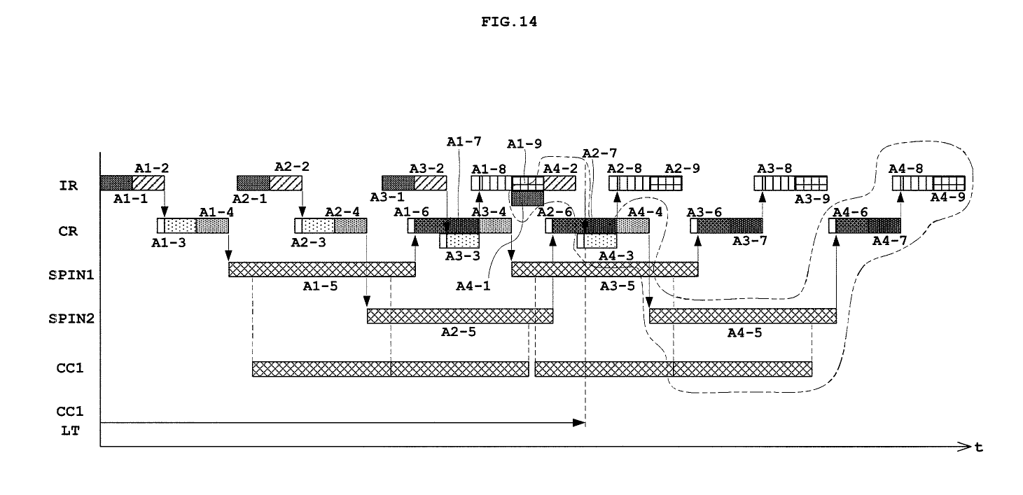

Next, an example of schedule preparation in the substrate treating apparatus constructed as described above will be described with reference to FIGS. 4-19. FIG. 4 is a flow chart showing schedule preparation. FIGS. 5-12 are time charts showing a schedule preparation process with the substrate treatment priority. FIGS. 13-19 are time charts showing a schedule preparation process with the maintenance priority.

First, description will be made taking for example a case where the priority setting is the maintenance priority. Here, in order to facilitate understanding of the invention, the process in simplified by limiting conditions such that two types of process job are set, neither having pretreatment or posttreatment, the treatment is done using a vacant one of the treating sections SPIN1 and SPIN2, and a chemical solution is supplied thereto from the chemical treatment section CC1.

It is assumed that one of the process jobs is associated with four substrates W, while the other process job is associated with two substrates W, with the same recipe applied to both. Here, a control job is left out of consideration. A specific recipe for the process jobs, as represented by the single schedule block shown in FIG. 5, is such that a substrate W is taken out of a cassette C by the indexer robot IR, is then loaded by the center robot CR into the treating section SPIN (1 or 2) to which the chemical solution is supplied by the chemical supply section CC1, is thereafter unloaded by the center robot CR, and is put into the cassette C by the indexer robot IR. In the time charts described hereinafter, sign A is used for the substrates W associated with one of the process jobs, sign B is used for the substrates W associated with the other, numerals are affixed to these signs to indicate numbers of the substrates W associated with the process jobs, and −numerals are affixed to these numerals to distinguish various steps of the treatment in the recipe for the substrates W.

Step S1

The user operates the setting unit 59 and instructs a start of scheduling. It is assumed here that “maintenance priority” has been set beforehand through the setting unit 59 as priority setting.

Step S2

The scheduling operation unit 53 of the controller 51 reads a recipe matched with a first substrate W which corresponds to the first in the order of treatment, prepares a single schedule as shown in FIG. 5, and treats it as a block. Regarding this block, if recipes were different, that is if recipes in the process job were different, plural types of blocks would be prepared. However, since the recipe is the same here, the block is also one.

Step S3

In allocating the block in the whole schedule, the scheduling operation unit 53 searches for a position where it can be allocated.

Step S4

The scheduling operation unit 53 allocates the block in the whole schedule (FIG. 6). At this point of time, since there are no blocks allocated and there arises no competition with other blocks for the resources, the block can be allocated to a treatment start position.

Step S5

The scheduling operation unit 53 determines whether a maintenance process is needed or not. Specifically, supposing, for example, that a lifetime from the time the chemical solution was produced in the chemical treatment section CC1 is set in the whole schedule, and that, as indicated by an arrow at CC1LT in FIG. 6, the tip end position thereof (i.e. the position indicated by a dotted vertical line) is the point of time the lifetime expires, a maintenance process can be determined unnecessary at the current time.

Step S10

The scheduling operation unit 53 determines whether or not the blocks of all substrates W have been allocated, and branches the operation. Here, since the blocks of substrates W remain to be allocated, the operation returns to step S2 to allocate the block of the next substrate W.

Steps S2 to S10 (Second Substrate W (A2-1 to A2-9))

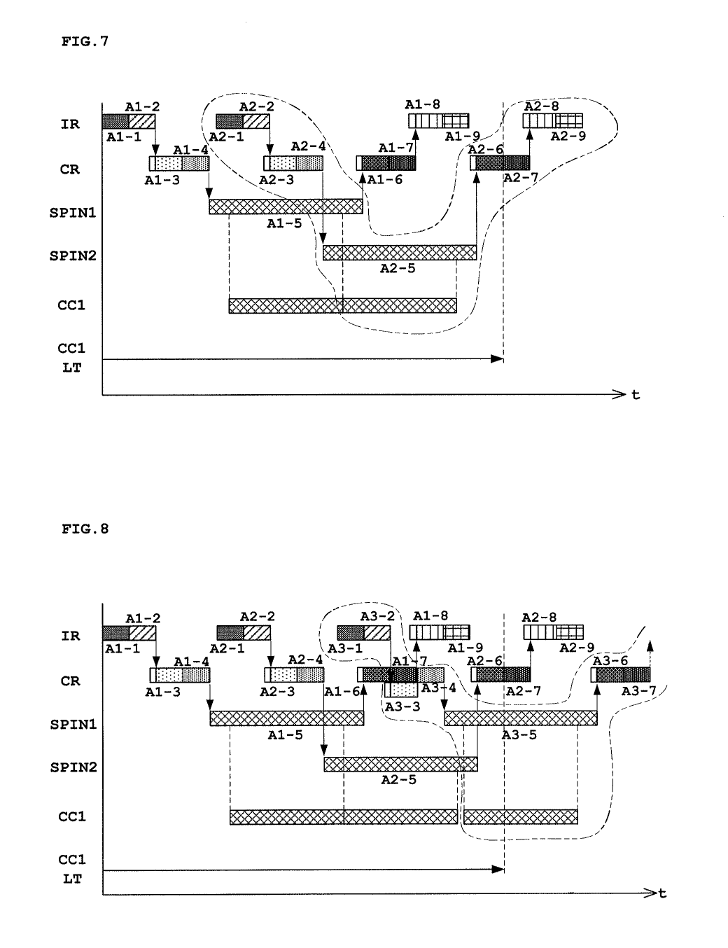

The scheduling operation unit 53 allocates the block (signs A2-1 to A2-9 in the drawings) of the second substrate W (FIG. 7). In the following description, the blocks immediately after allocation will be indicated as enclosed with two-dot chain lines. Since the chemical treatment section CC1 has not reached the expiry of lifetime, a maintenance process is determined unnecessary in step S5, and the operation branches to step S10.

Steps S2 to S10 (Third Substrate W (A3-1 to A3-9))

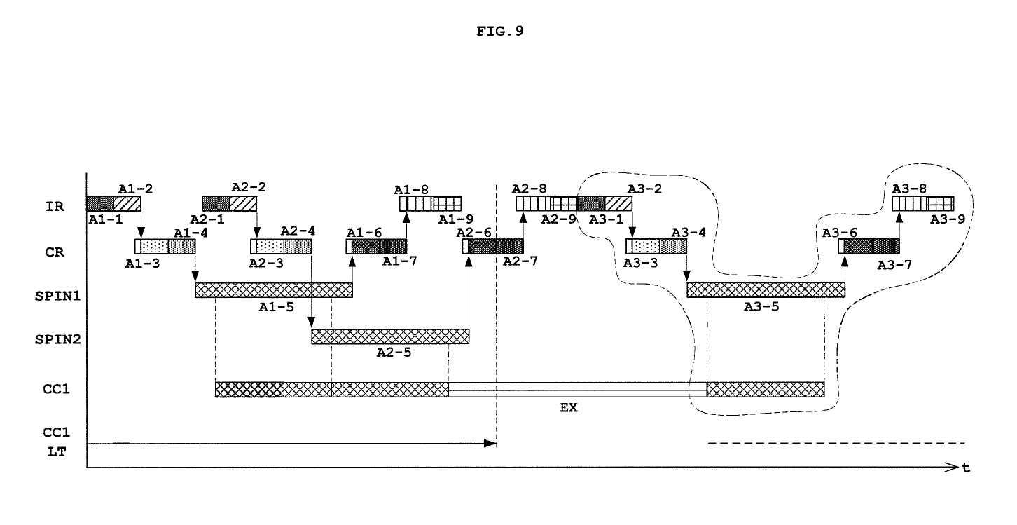

The scheduling operation unit 53 allocates the block (signs A3-1 to A3-9 in the drawings) of the third substrate W (FIG. 8). For expediency, FIG. 8 depicts only up to A3-7. Since the life of the chemical treatment section CC1 expires with allocation of the block of the third substrate W, a maintenance process is determined necessary in step S5, and the operation branches to step S6. And in step S6 the priority determining unit 55 determines that it is not the substrate treatment priority but the maintenance priority, whereby the operation branches to step S8. The block (signs A3-1 to A3-9 in the drawings) of the third substrate W is once deleted from the whole schedule, and as shown in FIG. 9, the maintenance process EX for changing the chemical solution is allocated to the chemical supply section CC1 in step S8. The block (signs A3-1 to A3-9 in the drawings) of the third substrate W is reallocated in step S9, and the operation returns to step S2. A lifetime (indicated by a horizontal dotted line) is newly set from the point of time when the maintenance process EX is completed.

Step S2 to S10 (Fourth Substrate W (A4-1 to A4-9))

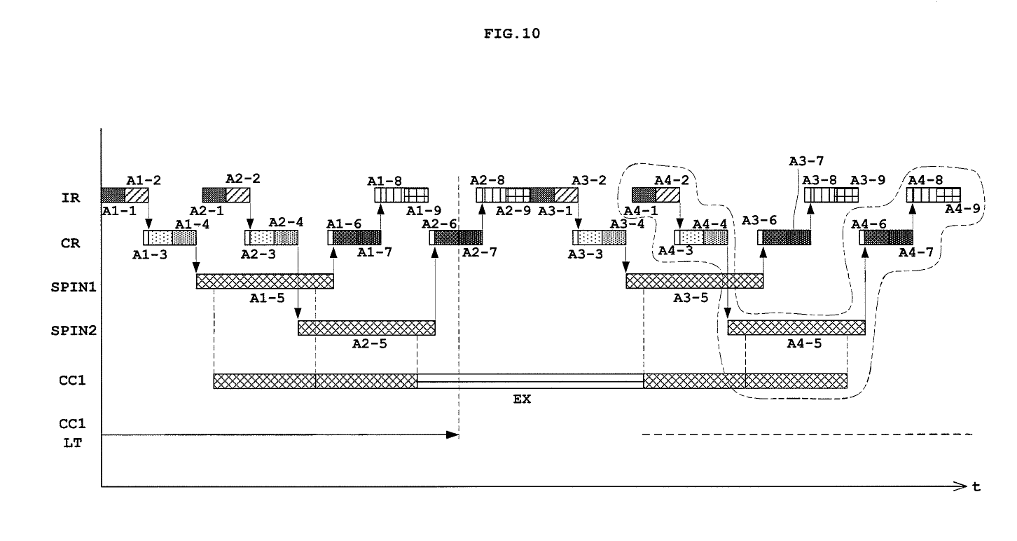

The scheduling operation unit 53 allocates the block (sign A4-1 to A4-9 in the drawings) of the fourth substrate W (FIG. 10). Since the chemical treatment section CC1 has not reached the expiry of the lifetime, a maintenance process is determined unnecessary in step S5, and the operation branches to step S10.

Steps S2 to S10 (First Substrate W (B1-1 to B1-9) in the Next Process Job)

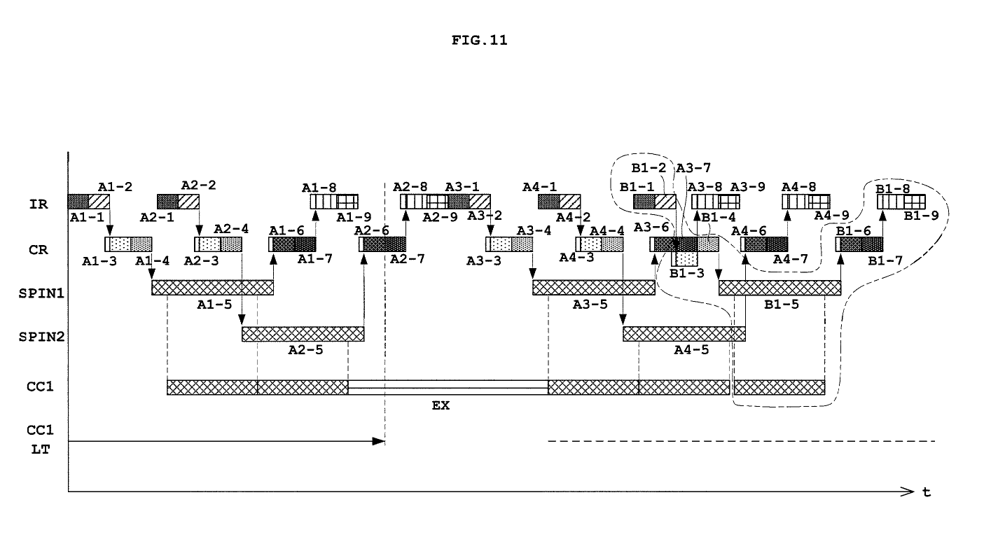

The scheduling operation unit 53 allocates the block (sign B1-1 to B1-9) of the first substrate W in the next process job (FIG. 11). Since the chemical treatment section CC1 has not reached the expiry of the lifetime, the maintenance process is determined unnecessary in step S5, and the operation branches to step S10.

On the center robot CR, A3-7 of the block A3-1 to A3-9 and B1-3 are in competition. However, as described hereinbefore, the center robot CR has the upper arm UA and lower arm LA to be capable of handling two substrates W almost simultaneously. It is therefore possible to allocate the blocks despite such competition.

This applies also to the indexer robot IR.

Steps S2 to S10 (Second Substrate W (B2-1 to B2-9) in the Next Process Job)

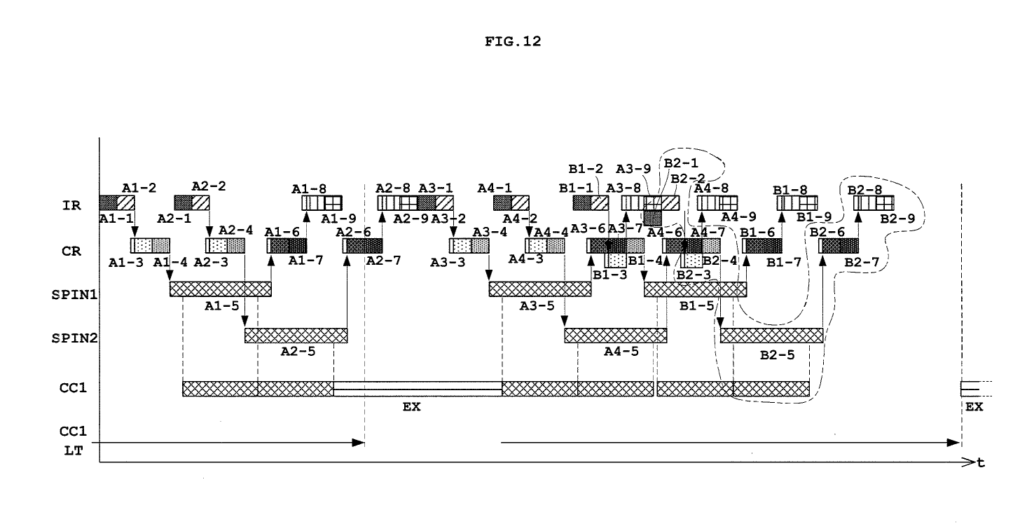

The scheduling operation unit 53 allocates the block (sign B2-1 to B2-9 in the drawings) of the second substrate W in the next process job (FIG. 12). Since the chemical treatment section CC1 has not reached the expiry of the lifetime, the maintenance process is determined unnecessary in step S5, and the operation branches to step S10.

After the allocation of the blocks is processed as described above, the scheduling operation unit 53 determines in step S10 that all the blocks have been allocated, and moves to step S11. Since a maintenance process is needed after the last block, the maintenance process EX is allocated in step S12 (FIG. 12). Then, the scheduling operation is ended.

Next, a scheduling for the four substrates W and two substrates W respectively assigned to the two process jobs as above will be described by taking for example a case of the priority setting being set to “substrate treatment priority”. An allocation timing of the maintenance process is assumed to have been set for each process job.

The scheduling process described above is the same up to the allocation of the block (signs A3-1 to A3-9 in FIG. 13) of the third substrate W which corresponds to FIG. 8. So description up to that stage will be omitted, and description will be made of operation performed thereafter.

Steps S3 to S7 (Third Substrate W (A3-1 to A3-9))

The scheduling operation unit 53, as shown in FIG. 13, allocates the block (signs A3-1 to A3-9 in FIG. 13) of the third substrate W, and then branches the operation according to whether or not the substrate treatment priority is determined by the priority determining unit 55. Specifically, in the case of substrate treatment priority, the operation branches to step S7, and in the case of maintenance priority, the operation branches to step S10. Here, after step S7 the operation branches to step S3. In the maintenance priority described above, the lifetime expires after allocation of the block (signs A3-1 to A3-9 in FIG. 13) of the third substrate W, and this block is therefore deleted and maintenance treatment is allocated. In this example, the block allocation is continued even when the lifetime has expired.

Steps S3 to S7 (Fourth Substrate W (A4-1 to A4-9))

After the scheduling operation unit 53, as shown in FIG. 14, allocates the block (signs A4-1 to A4-9 in FIG. 14) of the fourth substrate W, it is determined in step S5 that maintenance is necessary because the lifetime remains expired. However, since the substrate treatment priority is set, the operation branches from step S6 to step 7, and branches to step S3 to continue the allocation.

Steps S3 to S7 (First Substrate W (B1-1 to B1-9) in the Next Process Job)

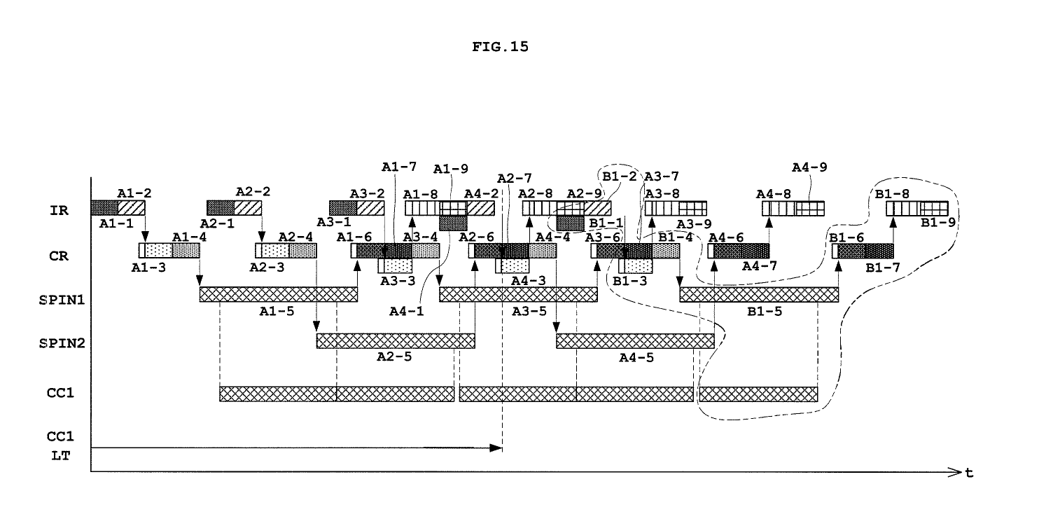

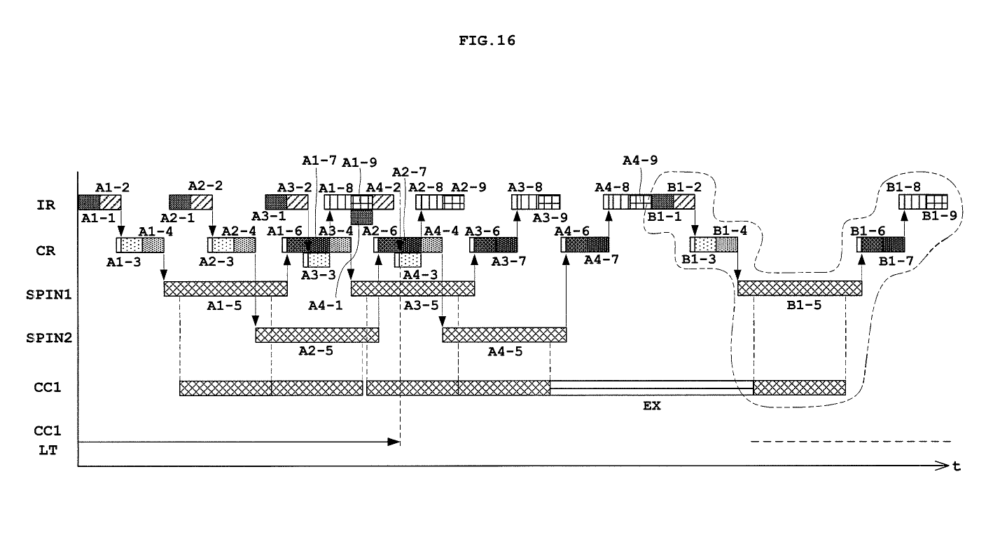

The scheduling operation unit 53, as shown in FIG. 15, allocates the block (sign B1-1 to B1-9 in FIG. 15) of the first substrate W in the next process job. Here, based on that the priority setting is the substrate treatment priority, that the allocation timing of the maintenance treatment is the process job, and that the process job has changed, the scheduling operation unit 53 branches to step S8 even if the priority setting is the substrate treatment priority in step S6. And the block (signs B1-1 to B1-9 in the drawings) of the first substrate W in the next process job is once deleted from the whole schedule, and as shown in FIG. 16, the maintenance process EX for changing the chemical solution is allocated to the chemical supply section CC1 in step S8. The block (signs B1-1 to B1-9 in the drawings) of the first substrate W is reallocated in step S9. Subsequently, the operation returns from step S10 to step S. A lifetime (indicated by a horizontal dotted line) is newly set from the point of time when the maintenance process EX is completed.

Steps S2 to S10 (Second Substrate W (B2-1 to B2-9) in the Next Process Job)

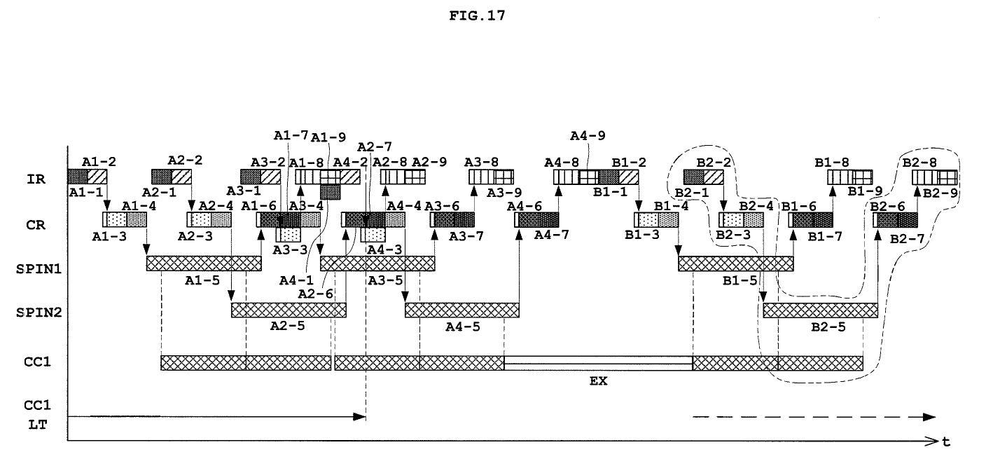

The scheduling operation unit 53 allocates the block (sign B2-1 to B2-9 in the drawings) of the second substrate W in the next process job (FIG. 17). Since the chemical treatment section CC1 has not reached the expiry of the lifetime, the maintenance process is determined unnecessary in step S5, and the operation branches to step S10.

After the allocation of the blocks is processed as described above, the scheduling operation unit 53 determines in step S10 that all the blocks have been allocated, and moves to step S11. Since a maintenance process is needed when the lifetime expires after the last block, the maintenance process EX is allocated in step S12 (illustration omitted). Then, the scheduling operation is ended.

According to this embodiment, as described above, when the maintenance process of the treating sections SPIN1-SPIN12 has reached its life at the time of allocating treatment of a certain substrate W which uses the resources of the treating sections SPIN1-SPIN12, the controller 51, based on a priority setting set beforehand by the user, allocates the treatment of the substrate W if the priority setting is substrate treatment priority, and allocates the maintenance process before the treatment of the substrate W if the priority setting is maintenance priority. This realizes treatment reflecting the desire of the user concerning the priority treatment.

When the priority setting is the substrate treatment priority, and when the setting is made for each process job as described hereinbefore, priority is given to the treatment of substrates even if a lifetime has expired. However, since the timing of allocating the maintenance process is set for each process job, the maintenance process is allocated between the process jobs. Consequently, treatment with different conditions occurs between the process jobs, but treatment with the same conditions is attained within each process job.

This invention is not limited to the foregoing embodiment, but may be modified as follows:

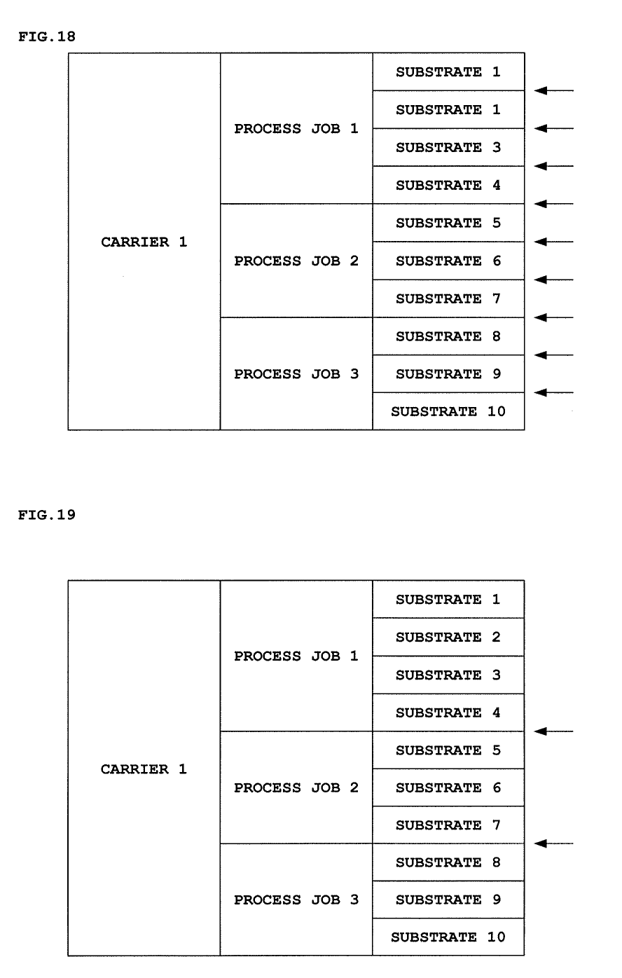

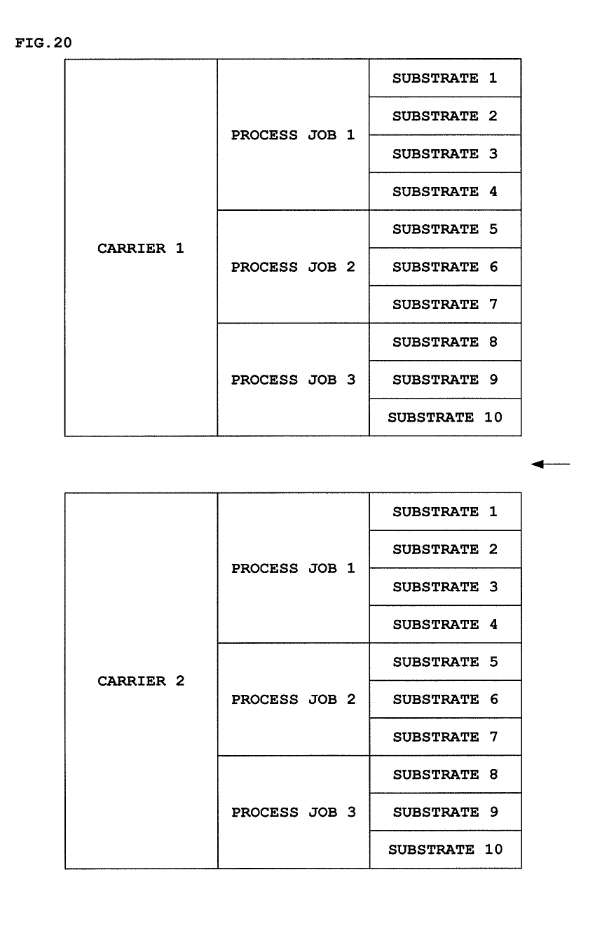

(1) In the foregoing embodiment, a setting for each process job has been described as an example of allocation timing of maintenance process with substrate treatment priority. This invention is not limited to such setting. Reference is made here to FIGS. 18 to 20. FIG. 18 is a schematic view showing an example of maintenance process timing with substrate treatment priority (each substrate). FIG. 19 is a schematic view showing an example of maintenance process timing with substrate treatment priority (each process job). FIG. 20 is a schematic view showing an example of maintenance process timing with substrate treatment priority (each control job). The arrows shown in these figures represent allocation timing of the maintenance process.

As shown in FIG. 18, the maintenance process timing may be set for each substrate. In this case, when life count is set to 1, for example, a maintenance process is allocated after treatment of each substrate W. This results in each substrate W receiving treatment with different conditions. Such setting is used, for example, when it is desired to treat each substrate W invariably with a new liquid.

As shown in FIG. 19, the maintenance process timing may be set for each process job. This example is the same as the foregoing embodiment. According to this, the conditions vary between the process jobs, but the same conditions exist within each process job.

As shown in FIG. 20, the maintenance process timing may be set for each control job. Since the control job shows to which carrier the substrates W belong, this means a setting for each carrier. That is, in this example, a maintenance process is allocated between carrier 1 and carrier 2. Therefore, the conditions vary between the carriers, but the same conditions exist within each carrier.

(2) In the foregoing embodiment, chemical solution changing has been described as an example of maintenance process. In this invention, the maintenance process is not limited to chemical solution changing. For example, the maintenance process may consist in a cleaning process for cleaning again the interiors of the treating sections SPIN1-SPIN12 in response to an elapsed time from the point of time of previous cleaning, or for cleaning again in response to the number of substrates W treated in the treating sections SPIN1-SPIN12.

(3) The foregoing embodiment has been described taking for example the case of scheduling in the substrate treating apparatus constructed as shown in FIG. 1. This invention is not limited to the substrate treating apparatus of such construction.

(4) The foregoing embodiment has been described taking for example the scheduling of substrates treated with the recipe shown in FIG. 5. This invention is not limited to this recipe only.

### INDUSTRIAL UTILITY

As described above, this invention is suitable for the technique of preparing a schedule before actually performing treatment.

### REFERENCE SIGNS LIST

W . . . substrates
C . . . carriers
ST1-ST4 . . . stages
IR . . . indexer robot
PS . . . pass section
CR . . . center robot
SPIN1-SPIN12 . . . treating sections
CC1, CC2 . . . chemical supply sections
UA . . . upper arm
LA . . . lower arm
51 . . . controller
53 . . . scheduling operation unit
55 . . . priority determining unit
57 . . . treatment instructing unit
59 . . . setting unit
61 . . . storage unit

1. A scheduling method for a substrate treating apparatus having a treating section for treating, one at a time, a plurality of substrates stored in a carrier, and a controller for determining resource use timing before actually starting treatment of the plurality of substrates using resources of the treating section;
wherein, when there is a maintenance process for the treating section having reached a life at a time of allocating treatment of a certain substrate which uses the resources of the treating section, the controller, based on a priority setting for one of a maintenance priority and a substrate treatment priority set beforehand by the user, allocates the treatment of the substrate in a case where the priority setting is the substrate treatment priority, and allocates a maintenance process before the treatment of the substrate in a case where the priority setting is the maintenance priority.

2. The scheduling method for the substrate treating apparatus according to claim 1, wherein:
a process job having set thereto a recipe specifying a sequence of treatment corresponding to each substrate, and
a control job having set thereto as to a pertinent carrier and corresponding to each substrate,
are set beforehand; and
the substrate treatment priority enables a setting of timing for allocating the maintenance process for one of each substrate, each process job, and each control job.

3. The scheduling method for the substrate treating apparatus according to claim 1, wherein the maintenance process is one of a liquid changing process for changing a liquid used in the treating section and a cleaning process for cleaning the treating section.

4. A scheduling program for a substrate treating apparatus having a treating section for treating, one at a time, a plurality of substrates stored in a carrier, and a controller for determining resource use timing before actually starting treatment of the plurality of substrates using resources of the treating section;
wherein, when there is a maintenance process for the treating section having reached a life at a time of allocating treatment of a certain substrate which uses the resources of the treating section, the controller, based on a priority setting for one of a maintenance priority and a substrate treatment priority set beforehand by the user, allocates the treatment of the substrate in a case where the priority setting is the substrate treatment priority, and allocates a maintenance process before the treatment of the substrate in a case where the priority setting is the maintenance priority.
